(19) United States
(12) Patent Application Publication
(10) Pub. No.: US 2026/0233759 A1
(43) Pub. Date: Aug. 13, 2026

(54) SYSTEM FOR EVALUATING PERFORMACE OF ARTIFICIAL INTELLIGENCE TO AUTOMATICALLY RECOGNIZE OBJECT BASED ON DATA FROM IMAGE SENSOR AND METHOD IMPLEMENTING THE SAME

(71) Applicants: Hyundai Motor Company, Seoul (KR); Kia Corporation, Seoul (KR)

(72) Inventor: Ho Tae SEO, Hwaseong-Si (KR)

(21) Appl. No.: 19/289,525

(22) Filed: Aug. 4, 2025

(30) Foreign Application Priority Data
Feb. 12, 2025 (KR) 10-2025-0017980

(51) Int. Cl. B60W 60/00; B60W 50/00; G06T 17/00

(52) U.S. Cl. CPC B60W 60/0027; B60W 50/0097; G06T 17/00; B60W 2050/0028; B60W 2420/40; B60W 2554/4044; G06T 2210/12

(57) ABSTRACT

A method performed by an apparatus of a vehicle may comprise inputting, based on at least one ground truth (GT) bounding box being set for an object, a three-dimensional (3D) image from a sensor into a first evaluation circuit coupled to the sensor and a learning model. The 3D image may comprise a plurality of objects. A plurality of predicted bounding boxes are obtained based on the learning model and multiple predictions. An intersection over union (IoU) value is determined, and false negatives (FNs), true positives (TPs), and a GT matching predicted bounding box are identified. At least one error is measured, and a signal indicating object recognition accuracy and the error is output to control autonomous driving of the vehicle.

### CROSS-REFERENCE TO RELATED APPLICATION

This application claims the benefit of priority to Korean Patent Application No. 10-2025-0017980 filed with the Korean Intellectual Property Office on Feb. 12, 2025, the entire contents of which are incorporated herein by reference.

### TECHNICAL FIELD

The present disclosure relates to a system and a method for evaluating performance of artificial intelligence (AI) that automatically recognizes objects through data from an image sensor, and more specifically, to a system for evaluating the performance of AI that automatically recognizes one or more objects existing in two-dimensional or three-dimensional image data obtained from various sensors such as LiDAR, and a method related thereto.

### BACKGROUND

The matters described in this Background section are only for enhancement of understanding of the background of the disclosure, and should not be taken as acknowledgment that they correspond to prior art already known to those skilled in the art.

Various sensors and artificial intelligence (AI) technologies may support autonomous driving functions of vehicles. For example, to support autonomous driving functions of vehicles, what object exists in front of a moving vehicle, what the distance is between the object and the vehicle, and what algorithm the vehicle should use to respond to specific situations may be considered.

Accordingly, high-performance sensors such as light detection and ranging (LiDAR) that recognizes a surrounding environment using a laser beam, radio detection and ranging (RADAR) that uses radio waves, ultrasonic sensors, fisheye cameras capable of shooting 360-degree images, multifocal lenses, and a global positioning system (GPS) may be installed in a vehicle for autonomous driving.

By integrating measurement results obtained from a plurality of sensors, it may be possible to implement a super sensor vehicle. In self-driving (autonomous driving), the super sensor vehicle may be able to more accurately recognize the surrounding environment by combining measurements from various sensors rather than relying on individual sensors for convenience and safety of driving. With the addition of information and communications technology (ICT) and cloud technology, sensors and AI algorithms used for autonomous driving may become sophisticated, not only for a single vehicle, but also for a fleet of vehicles, remotely accumulating data and training AI servers and databases to increase reliability of vehicle sensor determination.

Nonetheless, large and small errors may occur in sensor measurements of the vehicle or AI determination based on the sensor measurements. In particular, representative examples of errors include an error in a number of objects detected from an image sensor while driving, an error in a position of object cubes, and other false detections.

In vehicle driving, image sensors and object recognition technology may be directly related to safety of vehicle driving. Accordingly, a technology is considered to appropriately respond to object recognition errors.

### SUMMARY

The present disclosure provides a system and a related method for evaluating performance of AI to automatically recognize one or more objects existing in two-dimensional or three-dimensional image data obtained from a vehicle sensor.

That is, the present disclosure may accurately understand a situation or degree of errors related to object recognition by improving an evaluation algorithm for AI performance in recognizing objects. Improved error detection techniques will ultimately be the most important starting point for addressing a problem of object recognition errors.

However, the technical problems of the present disclosure are not limited to the technical problems mentioned above, and other technical problems not explicitly mentioned will be clearly understood by those skilled in the art from the detailed description of the present disclosure and the attached drawings.

In order to solve all or at least part of the above-described technical problems, the present disclosure may be implemented in various aspects as follows.

According to the present disclosure, a method performed by an apparatus of a vehicle, the method may comprise inputting, based on at least one ground truth (GT) bounding box being set for an object, a three-dimensional (3D) image obtained from a sensor into a first evaluation circuit of the apparatus, wherein the first evaluation circuit is coupled to the sensor and a learning model, and, wherein the 3D image may comprise a plurality of objects including the object, obtaining, based on the learning model and multiple predictions, a plurality of predicted bounding boxes, wherein the plurality of predicted bounding boxes recognize the object from the 3D image, determining, by the first evaluation circuit, an intersection over union (IoU) value by respectively comparing each of the plurality of predicted bounding boxes with the at least one GT bounding box, identifying a count of false negatives (FNs), a count of true positives (TPs), and a GT matching predicted bounding box, based on whether the IoU value is 0 and which predicted bounding box has a maximum IoU value relative to the at least one GT bounding box, measuring, by the first evaluation circuit, object recognition accuracy of the learning model by determining, based on the count of FNs, the count of TPs, and the GT matching predicted bounding box, at least one error of an object position error for each of the plurality of objects, an object size error for each of the plurality of objects, or an object heading error for each of the plurality of objects, and outputting a signal indicating the measured object recognition accuracy of the learning model and the determined at least one error, and controlling, based on the signal, autonomous driving of the vehicle.

The method, wherein the measuring of the object recognition accuracy may comprise determining whether object recognition results remain the same in a case where a front orientation and a back orientation of the GT matching predicted bounding box are reversed, and based on determining that the object recognition results differ, determining the object heading error by dividing the object heading error into an average heading error (AHE) and an average direction error (ADE), wherein the AHE and ADE are mutually independent metrics. The method may further comprise determining a value of a recognition error of the object within a range of 0 to 1 by assigning a maximum error value of 1 to prediction results corresponding to false negatives (FNs) among the plurality of predicted bounding boxes.

The method, wherein the determining of the value of the recognition error of the object may comprise determining an average error of the plurality of predicted bounding boxes based on the object position error, the object size error, and the object heading error, and determining, based on the determined average error, a recognition error of the object from the 3D image obtained from the sensor. The method may further comprise selecting, based on two or more predicted bounding boxes having non-zero IoU values, a predicted bounding box having a highest IoU value as the GT matching predicted bounding box. The method may further comprise determining an average location error (ALE) as the object position error, wherein the ALE is determined as a function of a number of predicted bounding boxes that have received the TP identification, a number of predicted bounding boxes that have received the FN identification, a plurality of correction variables associated with a central coordinate of the predicted bounding box and a central coordinate of the GT bounding box, and a Euclidean distance between the central coordinate of the predicted bounding box and the central coordinate of the GT bounding box.

The method, wherein the plurality of correction variables may comprise a first correction variable and a second correction variable that are natural numbers, and wherein the method further may comprise determining a mode value from a plurality of Euclidean distances between central coordinates of predicted bounding boxes and central coordinates of GT bounding boxes, identifying, through a search process, a natural number that most closely approximates the mode value by incrementing the first correction variable from 1 in units of 1, and setting the identified natural number as the second correction variable.

The method, wherein the Euclidean distance, the first correction variable, and the second correction variable are related such that a second derivative of a hyperbolic tangent function, applied to a product of the second correction variable and the Euclidean distance, equals zero at an inflection point, and the Euclidean distance is inversely proportional to the second correction variable and varies based on a ratio involving a square root term derived from the first correction variable. The method may further comprise determining an average dimension error (ADME) as the object size error, wherein the ADME is determined as a function of a number of predicted bounding boxes that have received the TP identification, a number of predicted bounding boxes that have received the FN identification, and an IoU value.

The method may further comprise determining the AHE as a function of a number of predicted bounding boxes that have received the TP identification, a number of predicted bounding boxes that have received the FN identification, a direction angle of the predicted bounding box, a direction angle of the GT bounding box, and a cosine-based expression representing a difference between the direction angle of the predicted bounding box and the direction angle of the GT bounding box. The method may further comprise determining the ADE as a function of a number of predicted bounding boxes that have received the TP identification, a number of predicted bounding boxes that have received the FN identification, a direction angle of the predicted bounding box, a direction angle of the GT bounding box, and a comparison operation based on a difference between the direction angle of the predicted bounding box and the direction angle of the GT bounding box equaling or exceeding a threshold angle.

According to the present disclosure, an apparatus of a vehicle, the apparatus may comprise a processor, and a memory storing at least one instruction that, when executed by the processor communicating with the memory, is configured to cause the apparatus to obtain, via a sensor of the vehicle, sensor data and a ground truth (GT) bounding box, wherein the sensor data may comprise a two-dimensional or three-dimensional image sensor data, recognize, based on a learning model, an object from the sensor data, and measure recognition accuracy of the learning model by determining an error between the recognized object and objects in an environment represented by the sensor data, even when a GT bounding box corresponding to a recognized object is absent.

The apparatus, wherein the at least one instruction, when executed by the processor communicating with the memory, is configured to cause the apparatus to recognize sensor data containing one or more objects belonging to at least one of a plurality of classes, while receiving at least one GT bounding box, repeatedly determine a predicted bounding box by recognizing the object based on the learning model from the sensor data, for each GT bounding box, respectively compare the predicted bounding boxes obtained by the repeated determination with the at least one GT bounding box to determine an intersection over union (IoU) value, identify a count of false negatives (FNs), a count of true positives (TPs), and GT matching predicted bounding boxes that are determined to match the at least one GT bounding box based on whether the IoU value is 0 and which predicted bounding box has a maximum IoU value, and measure the recognition accuracy of the learning model by determining, based on the count of FNs, the count of TPs, and the GT matching predicted bounding boxes, at least one error of an object position error for each of a plurality of objects, an object size error for each of the plurality of objects, or an object heading error for each of the plurality of objects.

The apparatus, wherein the at least one instruction, when executed by the processor communicating with the memory, is configured to cause the apparatus to determine whether object recognition results remain the same in a case where a front orientation and a back orientation of the GT matching predicted bounding boxes are reversed, and based on a determination that the object recognition results differ, determine the object heading error by dividing the object heading error into an average heading error (AHE) and an average direction error (ADE), wherein the AHE and ADE are mutually independent metrics.

The apparatus, wherein the at least one instruction, when executed by the processor communicating with the memory, is configured to cause the apparatus to determine a value of a recognition error of the object within a range of 0 to 1 by assigning a maximum error value of 1 to prediction results corresponding to false negatives (FNs) among the predicted bounding boxes. The apparatus, wherein the at least one instruction, when executed by the processor communicating with the memory, is configured to cause the apparatus to determine an average error of the plurality of predicted bounding boxes based on the object position error, the object size error, and the object heading error, and determine, based on the determined average error, a recognition error of the object from a 3D image obtained from the sensor.

The apparatus, wherein the at least one instruction, when executed by the processor communicating with the memory, is configured to cause the apparatus to determine an average location error (ALE) as the object position error, wherein the ALE is determined as a function of a number of predicted bounding boxes that have received the TP identification, a number of predicted bounding boxes that have received the FN identification, a plurality of correction variables associated with a central coordinate of the predicted bounding box and a central coordinate of the GT bounding box, and a Euclidean distance between the central coordinate of the predicted bounding box and the central coordinate of the GT bounding box.

The apparatus, wherein the at least one instruction, when executed by the processor communicating with the memory, is configured to cause the apparatus to determine an average dimension error (ADME) as the object size error, wherein the ADME is determined as a function of a number of predicted bounding boxes that have received the TP identification, a number of predicted bounding boxes that have received the FN identification, and an IoU value.

According to the present disclosure, a method performed by an apparatus of a vehicle, the method may comprise obtaining sensor data and reference data, wherein the sensor data represents a surrounding environment of the vehicle, and wherein the reference data comprises ground truth data including an annotation representing an object in the surrounding environment, identifying, using a learning model, at least one predicted object region from the sensor data, determining, based on a similarity measure between the at least one predicted object region and the reference data, a predicted object region, wherein the predicted object region corresponds to the object, outputting a signal indicating at least one error value associated with the predicted object region, wherein the at least one error value may comprise at least one of a position error, a size error, a heading error, or a directionality error, and controlling, based on the signal, autonomous driving of the vehicle.

The method, wherein the position error is determined by applying a hyperbolic tangent function to a distance between a center of the predicted object region and a center of the object associated with the reference data, such that effects of distance values larger than a threshold value are reduced.

Furthermore, various effects that may be understood by those skilled in the art are provided through the detailed description of the present disclosure and the attached drawings.

### BRIEF DESCRIPTION OF THE DRAWINGS

FIG. 1 illustrates a block diagram showing an example overall system for recognizing objects, evaluating AI object recognition performance, and controlling a vehicle for purposes such as autonomous driving.

FIG. 2 illustrates example GT bounding boxes input into an AI evaluation module and example predicted bounding boxes estimated by an AI algorithm in relation to arbitrary image data.

FIG. 3 illustrates a graph for describing an example reason for introducing a tangent function in operating an object positional error.

FIG. 4 illustrates a tangent derivative graph for describing an example method for determining first and second correction variables during computation of an object positional error.

FIG. 5 illustrates a flowchart showing an example overall process for evaluating performance of an object recognition algorithm

FIG. 6 illustrates a block diagram showing an example computing system for evaluating vehicle control and object recognition performance.

### DETAILED DESCRIPTION

Hereinafter, some examples of the present disclosure will be described in detail with reference to exemplary drawings. It should be noted that in adding reference numerals to constituent elements of each drawing, the same constituent elements include the same reference numerals as possible even though they are indicated on different drawings. In describing an example of the present disclosure, in a case where it is determined that a detailed description of the well-known configuration or function associated with the example of the present disclosure may obscure the gist of the present disclosure, it will be omitted.

In describing constituent elements according to an example of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which an example of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification. For example, in the present disclosure, the term ‘object’ essentially holds same meaning as ‘entity,’ and the expressions ‘object’ and ‘entity’ will be interchangeably used throughout the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of evaluating a recognition error of a 3D object based on a sensor and machine learning model) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of evaluating a recognition error of a 3D object based on a sensor and machine learning model) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of evaluating a recognition error of a 3D object based on a sensor and machine learning model) described herein.

Minimum risk maneuver (MRM) operation(s) may also be controlled, for example, based on one or more features (e.g., feature of evaluating a recognition error of a 3D object based on a sensor and machine learning model) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of evaluating a recognition error of a 3D object based on a sensor and machine learning model) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of evaluating a recognition error of a 3D object based on a sensor and machine learning model) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., feature of evaluating a recognition error of a 3D object based on a sensor and machine learning model) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

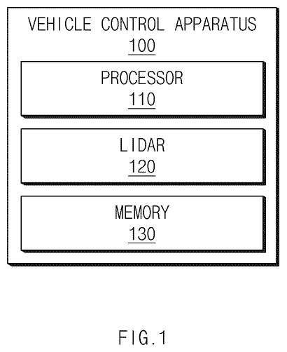

FIG. 1 illustrates a block diagram showing an example system for recognizing objects, evaluating AI object recognition performance, and controlling a vehicle for purposes such as autonomous driving.

Referring to FIG. 1, a vehicle control apparatus 100 according to an example may be implemented inside or outside a vehicle, and some of the components included in the vehicle control apparatus 100 may be implemented within onboard modules (e.g., an engine control circuit or infotainment system) or externally (e.g., in a trailer circuit, sensor housing, or roadside device), etc. In the instant case, the vehicle control apparatus 100 may be integrally formed with internal control units of the vehicle, or may be implemented as a separate device that is connected to control units of the vehicle by a separate connection means. For example, the vehicle control apparatus 100 may further include additional components not shown in FIG. 1 (e.g., a GPS module, a CAN interface controller, or a wireless communication transceiver, etc.).

The vehicle control apparatus 100 according to an example may include a processor 110, a LiDAR 120, and a memory 130. The processor 110, the lidar 120, or the memory 130 may be electronically and/or operably coupled with each other by an electronic component such as a communication bus.

Hereinafter, hardware components being operatively coupled may include a direct connection, and/or an indirect connection established between the hardware components, via wired, and/or wireless communication, such that a second hardware component is controlled by a first hardware component among the hardware components.

Although they are illustrated in different blocks, the examples are not limited thereto. For example, some of the hardware components in FIG. 1 may be included in a single integrated circuit (e.g., a system-on-chip (SoC), a multi-die package, or a printed circuit board module, etc.). A type and/or number of hardware included in the vehicle control apparatus 100 is not limited to that shown in FIG. 1. For example, the vehicle control apparatus 100 may include some of the hardware components illustrated in FIG. 1.

The vehicle control apparatus 100 according to an example may include one or more hardware components for processing data based on one or more instructions. For example, the hardware for processing data may include a processor 110. For example, the hardware for processing data may include an arithmetic and logic unit (ALU), a floating point unit (FPU), a field programmable gate array (FPGA), a central processing unit (CPU), and/or an application processor (AP) (e.g., an embedded ARM core, a RISC-V processor, or a digital signal processor (DSP), etc.). The processor 110 may be configured to have a single-core processor structure, or a multi-core processor structure including dual core, quad core, hexa core, octa core, or higher.

According to another example, the processor 110 may be configured to include at least one of a graphic processing unit (GPU), a neural processing unit (NPU), or any combination thereof (e.g., a CPU-GPU hybrid, a tensor processing unit (TPU), or a dedicated AI accelerator, etc.). For example, the GPU may be referred to as a visual processing unit (VPU). For example, the NPU may be referred to as a neural network processing unit.

The vehicle control apparatus 100 according to an example may include a depth sensor for detecting external objects. For example, the depth sensor for detecting external objects may include at least one of a time of flight (ToF) sensor, a light detection and ranging (LiDAR) 120, a structured light sensor, an ultrasonic sensor, an infrared sensor, a radio detection and ranging (RADAR), an optical distance sensor, or any combination thereof (e.g., stereo cameras, active laser triangulation, or multi-sensor fusion modules, etc.). Hereinafter, for better understanding and ease of description, a description will focus on the LiDAR.

The vehicle control apparatus 100 according to an example may include a LiDAR 120 that acquires a plurality of points based on a pulse laser signal. For example, the LiDAR 120 may acquire data sets that identify objects surrounding the vehicle control apparatus 100 (or a vehicle including the vehicle control apparatus 100). For example, the LiDAR 120 may identify at least one of a position, a moving direction, a speed, or any combination thereof of a surrounding object based on the pulse laser signal emitted from the LiDAR 120 being reflected back by the surrounding object (e.g., another vehicle, a pedestrian, a road barrier, or a traffic sign, etc.).

For example, the LiDAR 120 may obtain data sets representing external objects in a space formed by an x-axis, a y-axis, and a z-axis based on the pulse laser signal reflected from the surrounding object (e.g., vehicles, pedestrians, traffic signs, or buildings, etc.). For example, the LiDAR 120 may acquire data sets including a plurality of points in the space formed by the x-axis, the y-axis, and the z-axis based on receiving the pulse laser signal at designated time intervals. For example, the points may include points representing external objects within a 3D virtual coordinate system. The 3D virtual coordinate system may include at least one of a vehicle coordinate system, a LiDAR coordinate system, or any combination thereof (e.g., a sensor fusion frame, a global navigation frame, or a relative object frame, etc.). However, an example of the 3D virtual coordinate system is not limited to those described above.

The memory 130 of the vehicle control apparatus 100 according to an example may include a hardware component for storing data and/or instructions input to and/or output from the processor 110 of the vehicle control apparatus 100. For example, the memory 130 may include a volatile memory (e.g., random-access memory (RAM)), and/or a nonvolatile memory (e.g., read-only memory (ROM)).

For example, the volatile memory may include at least one of a dynamic RAM (DRAM), a static RAM (SRAM), a Cache RAM, a pseudo SRAM (PSRAM), or any combination thereof. For example, the nonvolatile memory may include at least one of a programmable ROM (PROM), an erasable PROM (EPROM), an electrically erasable PROM (EEPROM), a flash memory, a hard disk, a compact disc, a solid state drive (SSD), an embedded multi-media card (eMMC), or any combination thereof.

Within the memory 130 of the vehicle control apparatus 100, one or more instructions (or commands) indicating computations and/or actions to be performed by the processor 110 of the vehicle control apparatus 100 based on data may be stored. A set of one or more instructions may be referred to as a program, a firmware, an operating system, a process, a routine, a sub-routine, and/or an application (e.g., a path planning engine, or a sensor fusion script, etc.).

Hereinafter, a point that an application is installed in a vehicle control apparatus 100 may indicate that one or more instructions provided in a form of an application are stored in the memory 130, and that one or more applications are stored in a format that is executable by the processor 110 of the vehicle control apparatus 100 (e.g., a file having an extension designated by an operating system of the vehicle control apparatus 100) (e.g., a binary file, an ELF executable, or a containerized runtime module, etc.).

For example, the memory 130 may include a first neural network model for detecting an object. For example, the memory 130 may include a second neural network model for outputting types of the points acquired by the LiDAR 120 and/or scores of the points (e.g., class probabilities, confidence scores, or objectness values indicating likelihood that a particular region in an image or video contains an object, etc.).

In an example, the processor 110 may be configured to obtain at least one of a first virtual box representing a target object, a first class representing a type of the target object, or any combination thereof, based on the points acquired through the LiDAR 120 and the first neural network model stored in the memory 130.

For example, the processor 110 may be configured to obtain at least one of a first virtual box representing a target object, a first class representing a type of the target object, or any combination thereof, based on inputting a plurality of points into the first neural network model. For example, the first neural network model may include an object detection model (e.g., PointPillars, SECOND, PV-RCNN, or CenterPoint, etc.). For example, the target object (e.g., a nearby vehicle, a pedestrian, a roadside barrier, or a traffic cone, etc.) may include an external object positioned within a designated distance from the vehicle control apparatus 100 (or a vehicle including the vehicle control apparatus 100. For example, the target object may include an object that is identified by the vehicle control apparatus 100 and is continuously tracked (e.g., a leading car, a pedestrian in motion, or a cyclist crossing a path, etc.). For example, the type of the target object may include multiple types for classifying the target object. For example, the type of the target object may include at least one of a first type representing a ground, a second type representing a type that is different from the ground, or any combination thereof (e.g., animals, traffic cones, bicycles, or delivery robots, etc.). However, the type of the target object is not limited to what was described above. For example, the type of the target object may include at least one of a third type representing a person, a fourth type representing a vehicle, or any combination thereof (e.g., a cyclist, a delivery robot, a construction machine, or a stroller, etc.), but the present disclosure is not limited thereto.

In an example, the processor 110 may be configured to obtain, based on the points and the second neural network model, at least one of first partial points corresponding to at least a portion of the target object among the points, a second class identified through the first partial points and indicating the type of the target object, or any combination thereof. For example, the second neural network model may include a segmentation model (e.g., PointNet++, KPConv, or RangeNet++, etc.).

For example, the second neural network model may include a neural network model for obtaining types of multiple points and scores of the points (e.g., confidence values, semantic labels, or instance IDs, etc.).

For example, the processor 110 may be configured to obtain first partial points corresponding to at least a portion of the target object among the points based on inputting the points into the second neural network model (e.g., to isolate points belonging to a vehicle body, pedestrian torso, or sign structure, etc.). For example, the processor 110 may be configured to identify the types of the points based on inputting the points into the second neural network model (e.g., assigning each point a semantic label such as road, car, person, or background, etc.). For example, the processor 110 may be configured to obtain first partial points corresponding to at least a portion of the target object from among the points based on the type of each of the points (e.g., distinguishing object points from ground or background points, etc.).

In an example, the processor 110 may be configured to perform a first designated algorithm on the points. For example, the processor 110 may be configured to perform the first designated algorithm for classifying a type of each of the points for the points (e.g., using rule-based heuristics, geometric filters, or pre-trained classifiers, etc.). For example, the processor 110 may be configured to classify second partial points corresponding to a designated type among the points. For example, the designated type may include a type representing the ground (e.g., road surface, curbs, or parking areas, etc.).

For example, the processor 110 may be configured to classify the second partial points corresponding to a designated type based on performing the first designated algorithm on the points and obtain (or identify) the first partial points by excluding the second partial points from the overall point set (e.g., removing ground points, road markings, or low-confidence background points, etc.).

For example, the processor 110 may be configured to obtain at least one of a partial class for obtaining a second class, a score for each of the points, or any combination thereof, based on inputting the points into the second neural network model (e.g., a semantic segmentation network, an instance segmentation network, or a point-wise classifier, etc.). For example, the processor 110 may be configured to obtain a partial class and a score for each of the points based on inputting the points into the second neural network model (e.g., where the score indicates classification confidence, feature saliency, or objectness probability, etc.). For example, the partial class may contain a classification of each of the points into an arbitrary type (e.g., pedestrian, sedan, bus, pole, signboard, etc.).

For example, the processor 110 may be configured to fuse the partial class, the scores of each of the points, and the second partial points to generate an enhanced feature representation for object grouping. For example, the processor 110 may be configured to perform clustering based on fusing the partial class, the scores of each of the points, and the second partial points (e.g., using algorithms such as DBSCAN, K-means, or hierarchical agglomerative clustering, etc.). For example, the clustering may involve grouping first partial points that correspond to at least a portion of the target object (e.g., through DBSCAN, mean-shift, or voxel-based aggregation, etc.).

For example, the processor 110 may be configured to obtain a point cloud for generating a second virtual box based on the first partial points. For example, the processor 110 may be configured to obtain the point cloud based on grouping the first partial points (e.g., by aggregating spatially proximate and semantically similar points into a coherent structure, etc.).

For example, the processor 110 may be configured to generate a second virtual box, different from the first virtual box and for representing the target object, based on the point cloud (e.g., a refined 3D bounding box fitted to the clustered object points). For example, the second virtual box may include a box that includes at least some of the first partial points (e.g., points corresponding to the car body, pedestrian limbs, or cargo region, etc.).

For example, the processor 110 may be configured to identify a heading direction indicating a traveling direction of the target object based on at least one of the first partial points, the point cloud, or any combination thereof (e.g., estimating a forward vector based on temporal displacement or object orientation features, etc.).

For example, the processor 110 may be configured to identify a position of a second virtual box in a virtual coordinate system based on at least one of the first partial points, the point cloud, or any combination thereof (e.g., determining X/Y/Z location relative to the ego-vehicle coordinate frame, etc.). For example, the processor 110 may be configured to identify a size of the second virtual box based on at least one of the first partial points, the point cloud, or any combination thereof (e.g., computing length, width, and height of a pedestrian or vehicle from point spread, etc.). For example, the processor 110 may be configured to identify a second class based on at least one of the first partial points, the point cloud, or any combination thereof (e.g., classifying an object as a sedan, truck, or bus, based on its 3D geometry, etc.). For example, the processor 110 may be configured to identify at least one of the heading direction indicating the traveling direction of the target object, a position of the second virtual box in the virtual coordinate system, the size of the second virtual box, the second class, or any combination thereof, based on at least one of the first partial points, the point cloud, or any combination thereof (e.g., by analyzing spatial distribution, surface normals, temporal motion vectors, or semantic segmentation results, etc.). For example, the processor 110 may be configured to identify the heading direction of the bounding box based on at least one of the first virtual box, the first class, the heading direction of the second virtual box, the position of the second virtual box, the size of the second virtual box, the second class, or any combination thereof (e.g., by comparing orientation angles or velocity vectors associated with both bounding boxes, etc.). For example, the processor 110 may be configured to identify a position of the bounding box in the virtual coordinate system based on at least one of the first virtual box, the first class, the heading direction of the second virtual box, the position of the second virtual box, the size of the second virtual box, the second class, or any combination thereof (e.g., by triangulating between multiple box estimates, correcting based on object class-specific priors, or averaging positions from multiple frames, etc.). For example, the processor 110 may be configured to obtain a third class indicating a type of the target object corresponding to the bounding box based on at least one of the first virtual box, the first class, the heading direction of the second virtual box, the position of the second virtual box, the size of the second virtual box, the second class, or any combination thereof (e.g., resolving ambiguities between classes like SUV vs. pickup based on combined spatial and semantic cues, etc.). For example, the processor 110 may be configured to obtain at least one of the heading direction of the bounding box, the position of the bounding box in the virtual coordinate system, the third class indicating the type of the target object corresponding to the bounding box, or a combination thereof, based on at least one of the first virtual box, the first class, the heading direction of the second virtual box, the position of the second virtual box, the size of the second virtual box, the second class, or a combination thereof (e.g., by fusing geometric cues, semantic labels, and orientation information from multiple bounding box sources, etc.).

For example, the processor 110 may be configured to assign a first identifier to the second virtual box for tracking the second virtual box (e.g., a persistent object ID for multi-frame tracking, etc.). For example, the processor 110 may be configured to assign a second identifier corresponding to the first identifier to the bounding box (e.g., enabling association between LiDAR-based and perception-based bounding boxes, etc.).

For example, the processor 110 may be configured to track the bounding box using the second identifier (e.g., to maintain object identity across sequential LiDAR frames). For example, the processor 110 may be configured to track the target object based on identifying a plurality of bounding boxes that include a bounding box to which the second identifier is assigned, in a plurality of frames (e.g., enabling trajectory prediction or intent analysis, etc.). For example, the second identifier may be identifier assigned to a bounding box corresponding to the target object, so the processor 110 may be configured to track the target object by identifying the bounding boxes to which the second identifier is assigned in the frames (e.g., across consecutive LiDAR scans or synchronized camera frames, etc.).

In an example, the processor 110 may be configured to output a bounding box corresponding to the target object based on at least one of the first virtual box, the first class, the first partial points, the second class, or any combination thereof (e.g., by combining classification results and geometric features to generate a final detection output, etc.). For example, the bounding box may include an example of the target object represented in the virtual coordinate system in the form of a hexahedron (e.g., a cuboid with six rectangular faces defining the 3D extent of the object, etc.).

Hereinafter, operations performed by a CPU, a GPU, and/or an NPU included in the processor 110 will be briefly described.

In an example, the processor 110 may be configured to include at least one of a CPU, a GPU, an NPU, or any combination thereof. For example, at least one of the GPU, the NPU, or any combination thereof may obtain the first virtual box and the first class based on the first neural network model (e.g., an object detection model such as PV-RCNN or PointPillars, etc.). For example, at least one of the GPU or the NPU may acquire the first virtual box and the first class (e.g., by processing point cloud data through an object detection model, etc.). For example, at least one of the GPU, the NPU, or any combination thereof may obtain scores for each of the partial classes and the points for obtaining the second class based on the second neural network model (e.g., a point-wise semantic segmentation model, etc.). For example, at least one of the GPU or the NPU may obtain scores for each of the partial classes and the points for obtaining the second class based on the second neural network model (e.g., by computing classification confidence scores for each 3D point, etc.). For example, the CPU may classify second partial points corresponding to a designated type among the points based on performing the first designated algorithm for classifying types of each of the points (e.g., filtering out ground points using rule-based height thresholds or heuristics, etc.).

As described above, the vehicle control apparatus 100 according to an example may be configured to include at least one processor 110. The vehicle control apparatus 100 may be configured to accurately detect a target object (e.g., a nearby vehicle, pedestrian, or traffic structure, etc.) using at least one processor 110. Additionally, by performing parallel processes, the vehicle control apparatus 100 may be configured to reduce a load on each processor (e.g., offloading deep learning inference to the GPU while leaving logic tasks to the CPU, etc.).

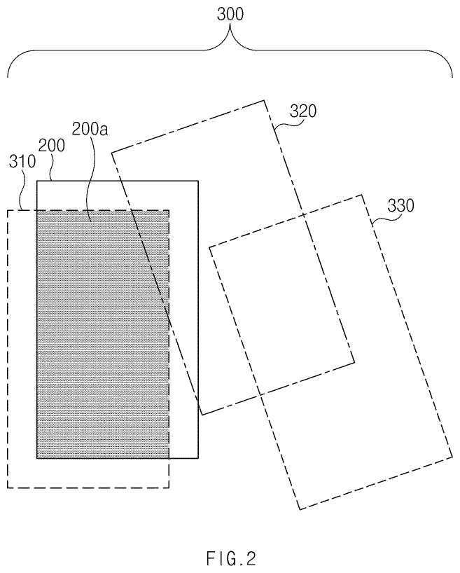

Next, with reference to FIGS. 2 to 6, an object recognition performance evaluation system and a method therefor according to an example of the present disclosure will be described. First, FIG. 2 and FIG. 8 may be referred to.

FIG. 2 illustrates example ground truth (GT) bounding boxes 200 input into an AI evaluation module and example predicted bounding boxes 300 estimated by an AI algorithm (e.g., machine learning model) in relation to arbitrary image data (e.g., LiDAR point clouds or camera frames, etc.), and

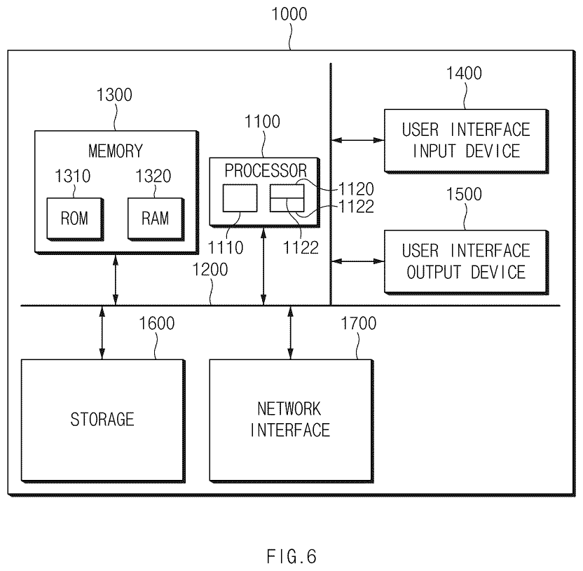

FIG. 6 illustrates a block diagram showing an example computing system 1000 for evaluating vehicle control and object recognition performance.

For example, the object recognition performance evaluation system 1000 according to the present disclosure may be viewed as a component that substantially corresponds to a computing system 1000 for vehicle control and object recognition performance evaluation illustrated in FIG. 6 (e.g., comprising hardware and software modules for executing detection and benchmarking algorithms, etc.). Particularly, the processor 1100 in FIG. 6 may be a core computational device that performs object automatic recognition and executes a performance evaluation algorithm for such automatic recognition according to the present disclosure (e.g., evaluating detection accuracy, latency, or classification precision, etc.) A user interface input device 1400 in FIG. 6 may function as a data input device 1400 that receives sensor data of a two-dimensional or three-dimensional image and a GT bounding box from an outside (e.g., via LiDAR, stereo cameras, or simulation data sources, etc.).

Furthermore, the processor 1100 of FIG. 6 may include an object recognition module 1110 that recognizes one or more objects using an AI algorithm (e.g., machine learning model) from various image sensor data such as LiDAR data according to the present disclosure.

The GT bounding box 200 illustrated in FIG. 2 may be a virtual box that is input from the outside into the object recognition performance evaluation system 1000 through the data input device 1400 according to the present disclosure. Herein, the meaning of ‘GT’ and ‘input from the outside’ are clarified.

In machine learning, GT (ground truth) is a term used to indicate an original or actual value of data that AI is trying to learn. Usually, it may be viewed as a type of image annotation as a bounding box with a box-shaped boundary, such as reference numeral 200 in FIG. 2 (e.g., a manually or semi-automatically drawn 3D box around a pedestrian, car, or road sign, etc.).

Of course, the GT annotation may not exist in the original data captured by sensors such as a LiDAR while the vehicle is driving. A first operation of object recognition may be for the processor 1100 to recognize objects belonging to various classes, such as road signs, crosswalks, pedestrians, other vehicles, and center lanes, as objects. The GT annotation may then be used as a reference to measure and evaluate object recognition errors by comparing an object determination result recognized by the AI algorithm (e.g., machine learning model) of the processor 1100 with an actual result. The GT bounding box, which is applied to an original image in the form of annotation, may be set manually by a user, but there is also a commercially available GT calculation tool, such as grid-striding or labeling platforms (e.g., CVAT, Supervisely, or Labelbox, etc.).

Accordingly, the GT bounding box 200 illustrated in FIG. 2 is input as a type of image annotation into the object recognition performance evaluation system 1000 according to the present disclosure, manually or through a GT computational tool such as grid-striding. Therefore, in the present disclosure, this is expressed as GT-related data being input from the outside (e.g., externally provided via human labeling, simulation output, or automated annotation software, etc.). As will be described later, the GT bounding box 200 is used in an AI evaluation module 1120 to evaluate object recognition performance.

On the other hand, the predicted bounding boxes 300 illustrated in FIG. 2 may represent results recognized by the object recognition module 1110 as objects of a specific class from original image data obtained from a LiDAR sensor, camera, or radar, etc. That is, three predicted bounding boxes 310, 320, and 330 illustrated in FIG. 2 may be results obtained by repeatedly performing an AI object recognition process of the object recognition module 1110 three times in total according to the present, and for convenience, in the present disclosure, these predicted bounding boxes 310, 320, and 330 may be collectively referred to as predicted bounding boxes 300 (e.g., to simplify performance comparison against the GT bounding box 200, etc.).

Unlike the GT bounding boxes 200, the predicted bounding boxes 300 may be AI calculation results (e.g., output of the machine learning model) that will be subject to performance evaluation. The predicted bounding boxes 300 may coincide with the GT bounding boxes 200, but may not coincide with the GT bounding box, or may not overlap at all, as illustrated in FIG. 2 (e.g., due to detection errors, occlusions, or misclassifications, etc.). For reference, the predicted bounding boxes 300 alone may not definitively determine that an object of a specific class actually exists at a certain position Therefore, the predicted bounding boxes 300 may be referred to P-Boxes (probability boxes) or predicted bounding boxes.

In an equation described below, a subscript pb (i.e., indicating a predicted bounding box or P-Box) may represent a bounding box predicted by the object recognition module 1110, along with various associated variables or parameters (e.g., coordinates, dimensions, or orientation angles, etc.). A subscript gt (i.e., indicating a ground truth bounding box) is used to represent a virtual box representing an actual object, along with various related variables, such as coordinate values or orientation angles, or dimensions (e.g., center position, yaw angle, or object width and height, etc.). This ground truth information serves as a reference point for comparison with the predicted bounding boxes 300 (e.g., for calculating intersection-over-union (IoU) or localization error, etc.).

Continuing to refer to FIG. 2, it may be seen that the object recognition module 1110 performs the object recognition algorithm a total of three times for an arbitrary LiDAR image, resulting in three predicted bounding boxes—310, 320, and 330—each corresponding to a separate inference pass or detection cycle (e.g., with different input augmentations or model configurations, etc.). The present disclosure focuses on performance evaluation of object recognition, so the GT bounding box 200 is also illustrated in FIG. 2 for convenience of understanding (e.g., to visually compare false positives, false negatives, and overlaps).

In a case of comparing the GT bounding box 200 with, e.g., the predicted bounding box 310, it may be easily confirmed that there is a region 200a where the GT bounding box 200 and the first predicted bounding box 310 overlap, and that this overlapping region 200a has the largest area compared to the areas where the other second and third predicted bounding boxes 320 and 330 overlap the GT bounding box 200 (e.g., indicating higher spatial agreement, object center alignment, or classification accuracy, etc.). Although a total of three AI computations were performed, AI computational results (i.e., object recognition results) were different across the three prediction cycles.

In fact, in FIG. 2, the third predicted bounding box 330 may not overlap with the GT bounding box 200 at all, and in the instant case, an intersection over union (IoU) value is said to be 0. This is because an area of an overlapping region between the third predicted bounding box (330) and the GT bounding box 200 is 0 (e.g., due to localization error, misclassification, or detection failure, etc.).

IoU may be one of the indicators frequently used to evaluate object recognition performance, and for example, the area of the overlapping region 200a compared to the total area of the GT bounding box 200 and the first predicted bounding box 310 may be defined as an IoU value. The IoU value being 0.5 or higher may generally indicate good performance of the object recognition module 1110, and the present disclosure is characterized by minimizing bias by enabling the object recognition module 1110 to repeatedly make predictions for each GT bounding box (e.g., across multiple inference passes, different time frames, or augmented sensor inputs, etc.), thereby preventing evaluation of object recognition performance from relying on particularly favorable prediction results (i.e., the first predicted bounding box 310) or particularly unfavorable prediction results (i.e., the third predicted bounding box 330) (e.g., by considering prediction consistency, robustness to noise, or temporal variation, etc.).

In addition, the present disclosure may be designed to generate predicted bounding boxes 300 like those in FIG. 2 for all pre-defined GT bounding boxes (e.g., cars, bicycles, traffic lights, or pedestrians, etc.), noting that multiple objects may exist within a single image. This ensures that AI performance evaluation incorporates objects with high misrecognition rates (e.g., a dog on the road, a road debris, or an unusual vehicle shape, etc., hypothetically assumed to have a high misrecognition rate here) as well as objects with low misrecognition rates (e.g., a traffic light, a bus, or a road sign, etc., hypothetically assumed to have a low misrecognition rate here), rather than limiting the evaluation to only objects with low misrecognition rates.

There are two additional aspects to consider in FIG. 2, specifically related to a calculation of a confusion matrix and determination of GT matching bounding boxes.

The confusion Matrix is one of the representative indicators for objectively evaluating prediction performance. In a confusion matrix technique, an AI prediction result are compared with an actual result to create a 2×2 matrix including four values: true positive (TP), false positive (FP), false negative (FN), and true negative (TN) (e.g., TP for correct detection, FP for false alarm, FN for missed detection, or TN for correct rejection, etc.). Herein, TP refers to a case where AI determined that an object exists, and that AI prediction was actually correct. FP refers to a case where AI determines that an object exists, but it turns out that the object does not actually exist. FN refers to a case where AI prediction determines that no object exists, but in reality, some object exists. TN refers to a case where AI prediction determines that no object exists, and this is confirmed to be correct upon actual verification (e.g., in empty road segments, background areas, or occluded regions, etc.).

In the present disclosure, it may be proposed to count FN by 1 in response to a case where there is no object with a non-zero IoU value as described above, and count TP by 1 in response to a case where there is an object with a non-zero IoU value (e.g., if the predicted bounding box sufficiently overlaps with the GT bounding box, exceeding a defined threshold such as 0.5, etc.). That is, in the example of FIG. 2, the FN count is 1 because of the third prediction bounding box 330, and the TP count is 2 because of the first and second prediction bounding boxes 310 and 320 (e.g., both exceeding the IoU threshold and matching the GT object class, etc.).

A reason why FP or TN is not necessarily counted in the present disclosure may be that, for example, during autonomous driving, a case in which an object that does not actually exist is incorrectly determined to exist (i.e., FP) or a case in which an object that does not actually exist is correctly recognized (i.e., TN) are considered less serious in relation to driving safety than the cases of FN or TP (e.g., failing to detect a real pedestrian is riskier than mistakenly detecting a bush as an object). Naturally, FP and TN will be reflected in computation of F1 Score based on the confusion matrix, and therefore, the present disclosure focuses on results of FN and TP at least (e.g., to ensure safer operational thresholds or real-time feedback tuning, etc.).

In fact, in the case of prior art, even an FN result was not reflected in evaluation of object recognition performance. The present disclosure is centered on incorporating FN—specifically instances where an object actually exists but is not recognized by the AI (i.e., an AI non-recognition scenario)—into the evaluation of object recognition performance, based on the premise that FN could have a severe impact on the safety of autonomous driving (e.g., failure to detect a pedestrian, cyclist, or stalled vehicle, etc.).

Furthermore, in FIG. 2, the object recognition module 1110 may determine what the GT matching bounding box is. For the GT matching bounding box, according to the present disclosure, in response to a case where there are two or more non-zero IoU results, the predicted bounding box with a largest IoU value may be determined as the GT matching bounding box (e.g., to avoid double-counting or mismatched associations, etc.). That is, in FIG. 2, the IoU value of the first predicted bounding box 310 is obviously greater than the IoU value of the second predicted bounding box 320, so the first predicted bounding box 310 will be determined as the GT matching bounding box (e.g., because it provides the best spatial alignment with the GT bounding box 200, etc.).

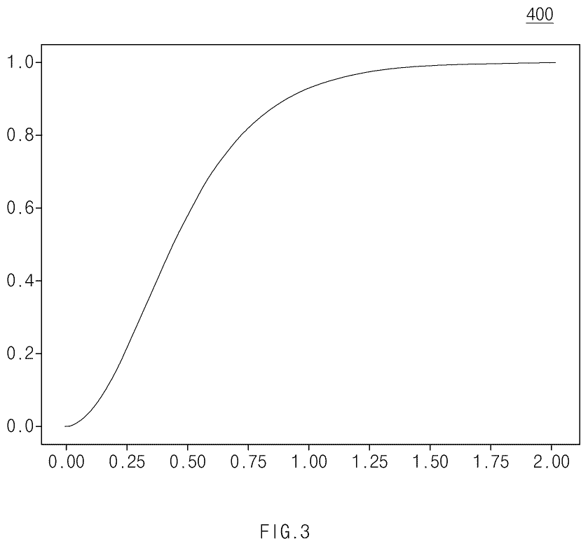

Next, a computation method of an object position error according to an example of the present disclosure will be described with reference to FIGS. 3, 4, 6, and equations below.

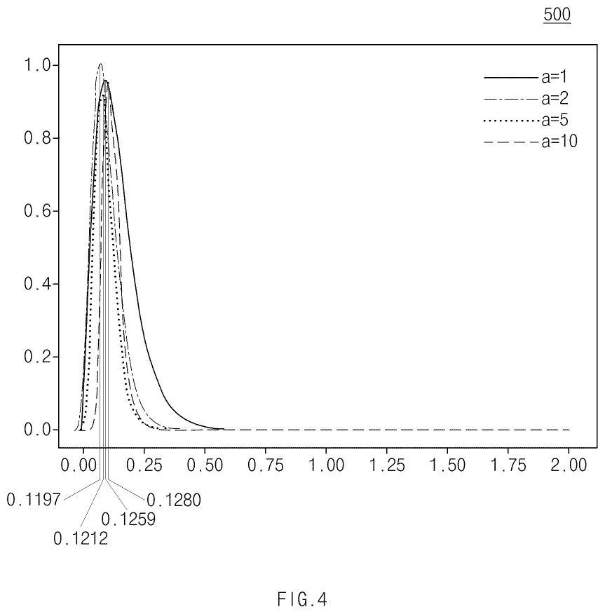

FIG. 3 illustrates a graph 400 for describing an example reason for introducing a tangent function in operating an object positional error, and FIG. 4 illustrates a tangent derivative graph 500 for describing an example method for determining first and second correction variables during computation of an object positional error (e.g., to penalize errors more heavily in certain angular zones, etc.).

As described above with reference to FIG. 6, the processor 1100 according to the present disclosure may be equipped with the AI evaluation module 1120. The AI evaluation module 1120 may be subdivided into a first evaluation module 1121 and a second evaluation module 1122, but for convenience of description, it will be described herein as an integrated AI evaluation module 1120.

In the present disclosure, the object position error is defined as an average location error (ALE), and the ALE is determined by the AI evaluation module 1120 according to following equations.

$$( Equation 1 )$$

$$ALE = \frac{\begin{matrix}{\sum }_{T P} {tanh ( k \sqrt{{( {x}_{p b} - {x}_{g t} )}^{2} + {( {y}_{p b} - {y}_{g t} )}^{2} + {( {z}_{p b} - {z}_{g t} )}^{2}} )}^{a} + \\ {num}_{FN}\end{matrix}}{( n u {m}_{T P} + n u {m}_{F N} )}$$

Herein, num_{TP} indicates a number of predicted bounding boxes that have received a true positive (TP) determination, num_{FN} indicates a number of predicted bounding boxes that have received a false negative (FN) determination, the variable a indicates a first correction variable, which is a natural number (e.g., 1, 2, or 3, etc.), k indicates a second correction variable, which is also a natural number. Meanwhile, (x_{pb}, y_{pb}, z_{pb}) indicates a center coordinate of the predicted bounding box, (x_{gt}, y_{gt}, z_{gt}) indicates a center coordinate of the above GT bounding box, and \sqrt{(x_{pb}−x_{gt})²+(y_{pb}−y_{gt})²+(z_{pb}−z_{gt})²} indicates a Euclidean distance between a center of the predicted bounding box and a center of the GT bounding box (e.g., to measure how far off the model prediction is from the actual labeled object location in 3D space, etc.).

$$\frac{{d}^{2}}{{dL}^{2}} {\{ tanh ( kL ) \}}^{2} = 2 {ak}^{2} \{ 1 - {tanh}^{2} ( kL ) \} {tanh}^{2 ( a - 1 )} ( kL ) \{ ( 2 a - 1 ) - 2 a \cdot {tanh}^{2} ( kL ) \} = 0 \qquad [ Equation 1 - 1 ]$$

$$L - \frac{1}{2 k} ln = \{ \frac{1 + \sqrt{1 - \frac{1}{2 a}}}{1 - \sqrt{1 - \frac{1}{2 a}}} \} \qquad [ Equation 1 - 2 ]$$

Herein, L indicates the Euclidean distance mentioned above, and is a concept that is applicable not only to 3D LiDAR image sensors but also to other 2D image sensors (e.g., RGB cameras, stereo vision systems, or infrared sensors, etc.) other than a LiDAR. Therefore, Equation 1 may be virtually identical to equations 1 to 3 (e.g., by substituting appropriate spatial inputs depending on the sensor type, etc.).

$$ALE = \frac{{\sum }_{TP} {tanh ( kL )}^{a} + n u {m}_{F N}}{n u {m}_{T P} + n u {m}_{F N}} \qquad [ Equation 1 - 3 ]$$

In the present disclosure, a reason a tangent function is introduced into Equation 1 may be observed in FIG. 3. That is, as mentioned earlier, (x_{gt}, y_{gt}, z_{gt}) indicates the center coordinate of the GT bounding box 200, and (x_{pb}, y_{pb}, z_{pb}) indicates the center coordinates of the predicted bounding boxes 310, 320, and 330 (e.g., representing detection outputs from different inference passes or model configurations, etc.). Referring to FIG. 2, the Euclidean distance of the first predicted bounding box 310 may be the shortest, and the Euclidean distance of the third predicted bounding box 330 may be the longest (e.g., indicating that prediction 310 is most accurate in terms of spatial alignment, while prediction 330 deviates significantly from the true object position, etc.).

In a case of computing the error, a so-called L2 Norm technique, which represents a Euclidean distance between two vectors (e.g., position vectors of ground truth and prediction, etc.), is often used. However, in a case of using the L2 Norm technique to determine an object position error, there is a problem that a L2 Norm computational value becomes excessively large in response to a case where there is a third predicted bounding box 330 or another predicted bounding box (not shown) recognized further away (e.g., due to sensor occlusion, misclassification, or incorrect object association, etc.). Herein, referring to the graph 400 of FIG. 3, it may be confirmed that in a case w the tangent function is applied to a L2 Norm result (corresponding to a horizontal axis of the graph 400), the object position error may be normalized to a value between 0 and 1 (corresponding to the vertical axis of the graph 400). That is, no matter how large the L2 Norm computational value is, according to Equation 1 of the present disclosure and Equation 1-3 which is virtually identical thereto, an error may be expressed as a decimal value (e.g., 0.78, 0.12, or 0.95, etc.).

For reference, Σ computation in Equations 1 and 1-3 is performed in a second AI evaluation module 1122. This is to evaluate a result of comprehensively performing object position errors for all objects (e.g., aggregate object position errors across all detected objects such as multiple vehicles, pedestrians, or traffic signs, etc.), and as described above, it is collectively referred to as the AI evaluation module 1120 for convenience of description.

Meanwhile, the present disclosure proposes an approach to introduce a first correction variable, a, which is a natural number, and a second correction variable, k, which is also a natural number, in Equation 1 and Equation 1-3 (e.g., to regulate curvature steepness and scale sensitivity of the tanh function, respectively, etc.). For describing the first and second correction variables, FIG. 4, Equations 1-2 and 1-3 may be referred to.

FIG. 4 illustrates the graph 500 of a derivative (i.e., differentiation) of a tangent function introduced according to the present disclosure in Equations 1 and 1-3. In the graph 500 of FIG. 4, a horizontal axis indicates a L2 Norm computational value, and a vertical axis indicates a result value of introducing the tangent derivative to make it easy to visually confirm an amount of change in the tangent graph 400 as in FIG. 3 (e.g., highlighting inflection zones or sensitivity shifts as the L2 input grows, etc.).

Referring to FIG. 4, an example is presented where four values of 1, 2, 5, and 10 are input to a first correction variable, a, which is a natural number. For example, in a case where the first correction variable a is 1, the Euclidean distance L in Equations 1-2 and 1-3 may be obtained for each AI test, allowing a value of the second correction variable k to be determined (e.g., by solving for k that aligns the inflection point with the observed distance distribution, etc.). Assuming that a most frequent Euclidean distance (mode value) from results of this test, based on FIGS. 2 and 3, is 0.125, the present disclosure is designed to search for a graph closest to the mode value of 0.125 (e.g., to align the curvature of the tanh function with the typical prediction error range, etc.) in FIG. 4. That is, an inflection point in the graph 500 of FIG. 4 may be identified by finding a point where the derivative of the tangent function becomes zero, as shown in Equation 1-1 and Equation 1-2 derived therefrom (e.g., where the rate of change in error sensitivity stabilizes, allowing optimal scaling of the ALE function, etc.) The present disclosure proposes a method to search for a natural number k that provides results closest to the mode value of 0.125 for the Euclidean distance, by incrementing the first correction variable a, which is a natural number, from 1 in steps of 1 (e.g., 1, 2, 3, . . . , or 10, etc.).

TABLE 1

| a | k | L |
|---|---|---|
| 1 | 7 | 0.1259 |
| 2 | 11 | 0.1197 |
| 5 | 15 | 0.1212 |
| 10 | 17 | 0.1280 |

As a result of substituting the first correction variable multiple times in a same manner as described above in Equations 1-2 and 1-3, it may be confirmed in Table 1 that in a case where the second correction variable is 7, the Euclidean distance becomes 0.1259, which is closest to the mode value of 0.125 (e.g., indicating the most frequently observed positional deviation in predicted bounding boxes). This is clearly demonstrated by the tangent derivative graph 500 of FIG. 4, where a graph with the inflection point of the tangent derivative closest to the horizontal axis L2 Norm at 0.125 corresponds to a case where a is 1.

That is, the present disclosure not only may evaluate AI performance using a L2 Norm computational value but also may apply the tangent function to a L2 Norm, enabling an object position error to be expressed as an error rate in a decimal unit or percentages (e.g., 0.36 or 36%, etc.), and furthermore, may establish a mode value as a most advantageous reference point for error analysis and follows a process to identify integers a and k that are closest to this mode value (e.g., to align the curvature and scale of the error function with commonly observed prediction behavior, etc.).

In summary, computation of the object position error in the present disclosure may incorporate FN results to more precisely determine object recognition errors, while introducing a tangent function into the L2 Norm technique for Euclidean distance and adding the first and second correction variables to enable optimal evaluation of object position errors (e.g., minimizing outlier sensitivity while preserving relative error trends, etc.). Furthermore, according to a method of counting FN and TP of the present disclosure described above, it may be possible to determine object position error by applying Equation 1 or Equation 1-3 even though the GT bounding boxes are not set for all objects in a given image (e.g., partial annotations, occluded objects, or sparsely labeled scenes, etc.).

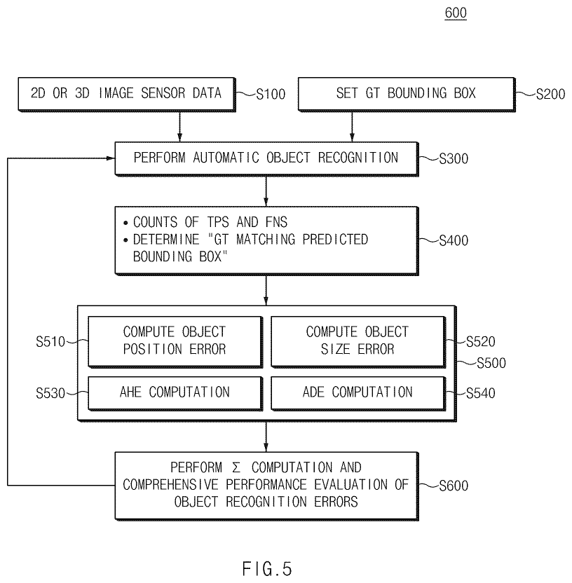

Now, a method for determining an object size error and an object heading error (which may be further subdivided into AHE and ADE) according to an example of the present disclosure will be described with reference to FIGS. 5 and 6 and Equations below.

FIG. 5 illustrates a flowchart 600 showing an example overall process for evaluating performance of an object recognition algorithm (e.g., incorporating detection, matching, error computation, and final scoring stages, etc.).

Meanwhile, in the present disclosure, the object size error may be defined as an average dimension error (ADME), and the ADME may be determined as shown in the following Equation 2.

$$ADME = \frac{{\sum }_{T P} ( 1 - IoU ) + n u {m}_{F N}}{n u {m}_{T P} + n u {m}_{F N}} \qquad ( Equation 2 )$$

As in equation 1, num_{TP} represents the number of predicted bounding boxes 300 classified as TP, num_{FN} represents the number of predicted bounding boxes 300 classified as FN. IoU represents the IoU value described above (e.g., the ratio of the overlap area to the union area between predicted and GT bounding boxes, etc.).

In addition, in a case of the present disclosure, the object heading error may be divided into two evaluation indices, an average heading error (AHE) and an average direction error (ADE), which are mutually independent, and the AHE may be determined using following Equation 3, and the ADE may be determined using following Equation 4, which is a feature of the present disclosure (e.g., to separately measure angle-based misalignment and general directional deviation, etc.).

$$AHE = \frac{{\sum }_{T P} \frac{1 - cos 2 ( {θ}_{p b} - {θ}_{g t} )}{2} + n u {m}_{F N}}{n u {m}_{T P} + n u {m}_{F N}} \qquad ( Equation 3 )$$

Herein, θ_{pb} indicates a direction angle of the predicted bounding box, θ_{gt} indicates a direction angle of the GT bounding box. In other words, the AHE indicates an index that reflects the angular difference between a direction in which an identified object in an image is actually facing and a direction determined by AI for the object as an object heading error (e.g., whether a vehicle is facing forward vs. being misinterpreted as rotated 180°, etc.).

$$ADE = \frac{{\sum }_{TP , \vert {θ}_{p b} - {θ}_{g t} \vert > \frac{π}{2}} 1 + {num}_{F N}}{n u {m}_{T P} + n u {m}_{F N}} \qquad ( Equation 4 )$$

To overcome a limitation of Equation 3 that it cannot analyze a case where front and back of an object are switched, the present disclosure may propose to use Equation 4 as an algorithm for enhanced determination of the object heading error. That is, the core of Equation 4 may be to set the error to a maximum value of 1 for predicted bounding boxes where the heading error exceeds ±90 degrees and reflect it in ADE computation, and to set the error to 0 for cases where the heading error is equal to or less than ±90 degrees so it may not distort the ADE computation (e.g., if minor directional offsets are not safety-critical, etc.). In summary, in a case where the heading errors of all the predicted bounding boxes 300 fall within ±90 degrees, the object heading error AHE will remain as a valid evaluation metric, and ADE will become 0 (e.g., indicating that no reverse-facing misinterpretations occurred, which could otherwise be safety-relevant for tasks like lane tracking or vehicle orientation analysis, etc.).

As shown in Equations 3 and 4, the present disclosure may evaluate whether a recognition result of an object is the same even in a case where front and back of a GT matching predicted bounding box are switched, and in a case where it is evaluated that they are not the same, the object heading error may be independently determined by dividing it into two separate evaluation indices: AHE and ADE (e.g., to separately capture angular differences within ±90° and full directional reversals beyond ±90°, etc.).

Of course, as in a case of Equation 1 above, in Equations 2 to 4, Σ computation may be performed by the second evaluation module 1122 among the AI evaluation modules 1120 of FIG. 6, and computation of a previous operation of Σ may be performed by the first evaluation module 1121 (e.g., initial IoU filtering, bounding box association, and angle calculation, etc.).

Now, referring to FIG. 5, the object recognition performance evaluation algorithm 600 according to the present disclosure may first receive two-dimensional or three-dimensional image sensor data from the outside according to an operation S100. Image sensor data may be three-dimensional data including depth information (e.g., from LiDAR or stereo vision), or may simply be a two-dimensional image (e.g., from RGB cameras), and further, data in which multiple sensor data including two-dimensional sensors and three-dimensional sensors are fused may be input as sensor data through the data input device 1400 in the operation S100 (e.g., radar-LiDAR fusion or camera-depth hybrid streams, etc.).

Furthermore, sensor data input in the operation S100 may be a dataset prepared in advance for AI machine learning. For example, a dataset, which is NUSCENES BY MOTIONAL™, is designed for AI object recognition training related to autonomous driving. The NUSCENES BY MOTIONAL™ dataset, captured in highly congested regions of Boston and Singapore, provides 1,000 driving scenes for AI training purposes, featuring objects classified into 23 categories, and even offering annotated GT bounding boxes. Furthermore, 20 seconds of driving screen data may also be provided to enable AI to learn situations that are difficult to predict while driving (e.g., occluded vehicles, jaywalking pedestrians, or sudden stops, etc.).

In an operation S200, for example, in parallel with the operation S100, settings related to the GT bounding box 200 may be input from the outside. As described above, the GT bounding box 200 may be input into the object recognition performance evaluation system 1000 illustrated in FIG. 6 by manually setting the GT bounding box by a user or by using a separate program that automatically sets the GT bounding box (e.g., via annotation tools like CVAT or automated labeling models, etc.).

In an operation S300, an AI algorithm mounted on the processor 1100 may be configured to automatically recognize one or more objects existing in given sensor data and generate multiple predicted bounding boxes 300 as illustrated in FIG. 2 (e.g., identifying vehicles, pedestrians, bicycles, or traffic signs from LiDAR or camera input, etc.).

In an operation S400, the first evaluation module 1121 among the AI evaluation modules 1120 may be configured to count counts of TPs and FNs based on a result of the operation S300 executed multiple times for each GT bounding box, and select the predicted bounding box with a greatest IoU value as the GT matching predicted bounding box (e.g., using a greedy IoU matching algorithm or Hungarian assignment, etc.).

Notably, the operations S300 and S400 may be repeatedly performed for each GT bounding box in a case where multiple GT bounding boxes exist. Furthermore, it may be entirely possible to change a system configuration to run operations S300 through S500 and S600 described later on a cloud server (e.g., using cloud-hosted inference and evaluation pipelines for scalability, etc.).

In the operation S500, the first evaluation module 1121 may be configured to determine an object position error (operation S510) and an object size error (operation S520) based on Equations 1 to 4 described above (e.g., using ALE for location deviation and ADME for size mismatch between predicted and GT bounding boxes, etc.). In the object size error determination method based on Equation 2, IoU values other than 0 are treated as TP in the operation S400, so a wide range of the IoU values may be appropriately reflected in the object position error (e.g., capturing both tightly and loosely overlapping predictions, etc.).

Notably, IoU inherently ranges between 0 and 1, so the present disclosure may determine that introducing a tangent function into Equation 2, as in Equation 1, is not strictly necessary for determining object size errors (e.g., because IoU already behaves as a normalized error signal between predicted and ground truth bounding boxes, etc.).

An operation S530 may compute the object heading error. Of course, the present disclosure may evaluate whether a recognition result of an object is the same even in a case where front and back of a GT matching predicted bounding box are switched or reversed (e.g., due to symmetrical object shapes, sensor occlusions, or labeling ambiguity, etc.), and in a case where it is evaluated that they are not the same, the object heading error may be independently determined by dividing it into independent AHE (computed in the operation S530) and ADE (computed in an operation S540) evaluation indices (e.g., to distinguish between minor angle shifts and complete directional reversals, etc.). In fact, the operations S510 to S540 may all be performed independently by the first evaluation module 1121.

The operation S530 may determine the heading error solely from a perspective of AHE, disregarding cases where front and back of the predicted bounding box are switched (e.g., considering only the absolute angular difference). In contrast, the operation S540 may be a procedure for evaluating AI performance in cases where the front and back of the predicted bounding box are misaligned (e.g., a 180-degree flipped detection).

In an operation S600, the second evaluation module 1122 may perform a comprehensive performance evaluation of object recognition errors by performing Σ computations defined in Equation 1 to Equation 4 (e.g., aggregating per-object errors over the full dataset, scene, or test batch, etc.). Of course, the operation S600 may also independently determine errors in four aspects: object position, size, AHE, and ADE (e.g., to allow for fine-grained tuning of recognition models based on specific error trends, such as mis-localization versus orientation misestimation, etc.). However, if necessary, by applying predetermined weights to execution results of the operations S510 to S540, it may be possible to derive a single performance evaluation score that comprehensively reflects errors in the four aspects of object position, size, AHE, and ADE (e.g., using a weighted sum or normalized metric fusion approach, etc.).

Furthermore, based on a result of the operation S600, it may be possible to provide real-time feedback by improving, modifying, or replacing the AI algorithm used for automatic object recognition in the operation S300, if necessary (e.g., retraining the model, adjusting detection thresholds, or replacing the model backbone, etc.).

FIG. 6 illustrates a block diagram showing an example computing system for evaluating vehicle control and object recognition performance.

Referring to FIG. 6, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media (e.g., DRAM, SRAM, NAND flash, or magnetic disks, etc.). For example, the memory 1300 may include a read only memory (ROM) and a random access memory (RAM).

Accordingly, steps of a method or algorithm described in connection with the examples included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific IC (ASIC). The ASIC may reside within a user terminal (e.g., an autonomous vehicle control unit, an edge inference box, or a smart camera system, etc.). Alternatively, the processor and the storage medium may reside as separate components within the user terminal.

A first aspect of the present disclosure relates to a system for evaluating object recognition errors using an artificial intelligence (AI) algorithm. An example of the present disclosure provides a system including a data input device configured to receive sensor data of a two-dimensional or three-dimensional image sensor data and a GT bounding box from an outside; an object recognition module configured to recognize one or more objects using the AI algorithm from the sensor data; and a first evaluation module configured to primarily evaluate performance of the AI algorithm through an error computation, performing the error computation between the AI-recognized object and the object existing in the sensor data, even in a case where the GT bounding box set for the AI-recognized object does not exist.

In a case of the object recognition performance evaluation system according to a second aspect of the present disclosure, the AI algorithm may execute a first process for recognizing sensor data containing one or more objects belonging to at least one of a plurality of classes, while receiving at least one GT bounding box; a second process for repeatedly computing a predicted bounding box by recognizing the object by AI from the sensor data, respectively comparing the predicted bounding boxes obtained by the repeated process with the GT bounding box(es) to determine a IoU value, and determining a count of FNs, a count of TPs, and GT matching predicted bounding boxes that are evaluated to match the GT bounding boxes based on whether the IoU value is 0 and a maximum magnitude of the IoU value; and a third process for evaluating the object recognition performance of the AI algorithm itself by independently computing at least one of an object position error, an object size error, or an object heading error for each of the one or more objects based on the count of FNs, the count of TPs, and the GT matching predicted bounding boxes.

In a case of the object recognition performance evaluation system according to a third aspect of the present disclosure, the third process may include a process of evaluating whether object recognition results are identical even in a case where front and back of the GT matching predicted bounding boxes are switched, and, in response to determining that they are not identical, independently computing the object heading error by dividing it into mutually independent evaluation metrics, an average heading error (AHE) and an average direction error (ADE).

In a case of the object recognition performance evaluation system according to a fourth aspect of the present disclosure, the recognition error of the object may be computed within a range of 0 to 1 by defining prediction results of the AI algorithm corresponding to the FNs among the predicted bounding boxes as a maximum error of 1 in the second process.

The object recognition performance evaluation system according to a fifth aspect of the present disclosure may further include a second evaluation module linked to the above first evaluation module, the AI algorithm additionally executes a fourth process for computing an average error of all the predicted bounding boxes based on the object position error, the object size error, and the AHE and ADE evaluation metrics included in the object heading error, computed by the first evaluation module through the second evaluation module, and finally evaluating the recognition error of the object for the sensor data and the AI algorithm based on the average error.

Meanwhile, a sixth aspect of the present disclosure relates to a method for evaluating a recognition error of a three-dimensional object using LiDAR and an AI (Artificial Intelligence) algorithm. That is, the method is suggested, including: a first operation of inputting, by a processor, a three-dimensional LiDAR image including one or more objects belonging to at least one of a plurality of classes into a first evaluation module linked to the LiDAR and the AI algorithm, while setting at least one ground truth (GT) bounding box for the object; a second operation of performing, by the AI algorithm, multiple computations on a predicted bounding box recognizing the object from the input 3D LiDAR image, and then determining, by the first evaluation module, an intersection over union (LoU) value by respectively comparing predicted bounding boxes obtained by the multiple computations with the GT bounding boxes and determining a count of false negatives (FNs), a count of true positives (TPs), and a GT matching predicted bounding box evaluated to match the GT bounding box based on whether the IoU value is 0 and a maximum magnitude of the IoU value; and a third operation of evaluating, by the first evaluation module, object recognition performance of the AI algorithm by independently determining at least one error among an object position error, an object size error, or an object heading error for each of the one or more objects based on the count of FNs, the count of TPs, and the GT matching predicted bounding boxes.

In a case of the object recognition performance evaluation method according to a seventh aspect of the present disclosure, the third operation may include evaluating whether object recognition results are identical even in a case where front and back of the GT matching predicted bounding boxes are switched, and, in response to determining that they are not identical, independently computing the object heading error by dividing it into mutually independent evaluation metrics, an average heading error (AHE) and an average direction error (ADE).

In a case of the object recognition performance evaluation method according to an eighth aspect of the present disclosure, the recognition error of the 3D object may be computed within a range of 0 to 1 by defining prediction results of the AI algorithm corresponding to the FNs among the predicted bounding boxes as a maximum error of 1 in the second operation.

In a case of the object recognition performance evaluation method according to a ninth aspect of the present disclosure, it may further include a fourth operation of computing, by a second evaluation module linked to the first evaluation module, an average error of all the predicted bounding boxes based on the object position error, the object size error, and the AHE and ADE evaluation metrics included in the object heading error, computed by the first evaluation module, and finally evaluating the recognition error of the 3D object for the LiDAR and the AI algorithm based on the average error.

In a case of the object recognition performance evaluation method according to a tenth aspect of the present disclosure, the first evaluation module may be configured to measure the counts of the FNs and the TPs for the predicted bounding boxes, wherein it counts a case where there are no objects having an IoU value other than zero relative to the GT bounding box for the LiDAR image containing one or more objects as one FN, counts a case where there are objects having an IoU value other than zero relative to the GT bounding box as one TP, and determine the predicted bounding box with a highest IoU value as the GT matching predicted bounding box in response to a case where there are two or more objects having an IoU value other than zero, in the second operation.

The present disclosure proposes a new technique for evaluating errors or inaccuracies that may occur in automatically recognizing objects from sensor data of two-dimensional or three-dimensional images. The features and effects of the present disclosure are summarized as follows.

First, according to this disclosure, AI performance evaluation may be possible regardless of whether a GT bounding box exists. The GT bounding box may usually be created by drawing a virtual box surrounding an object in a two-dimensional or three-dimensional image, either manually or using a separate GT bounding box input program, and in the instant case, there may often be multiple objects in a single image, so this overcomes a problem of the prior art that AI performance had to be evaluated on assumption that a GT bounding box exists for each and every object.

For example, in a case where the first evaluation module according to the present disclosure measures counts of FNs and TPs for predicted bounding boxes, a case where there is no object with a non-zero IoU value may be counted as 1 FN, and a case where there is an object with a non-zero IoU value may be counted as 1 TP, and in a case where there are two or more objects with non-zero IoU values, an AI predicted bounding box with a greatest IoU value may be determined as a GT matching predicted bounding box, which is based on a premise that a GT bounding box may not exist for all objects in a given image.

Second, according to this disclosure, it is designed to reflect performance evaluation even in an unrecognized situation where the AI fails to recognize an actually existing object. In other words, according to the present disclosure, a count of FNs in the predicted bounding boxes is counted and reflected in performance metrics, so situations where the AI completely fails to recognize an object may be accurately incorporated into the object recognition performance evaluation.

Third, the present disclosure may define object recognition errors into four types: positional errors, size errors, AHE-type errors, and ADE-type errors, and may also introduce a new mathematical algorithm to compute each of these errors.

Fourth, in the present disclosure, by introducing a tangent function for calculating object positional errors, it may address evaluation errors where extreme inaccuracies are excessively negatively reflected in performance assessments.

Accurately evaluating object recognition performance is essential to improving autonomous driving performance. While errors may exist in both the measurements of vehicle sensors utilizing LiDAR and AI interpretation results distinguishing objects from LiDAR data, accurately evaluating these AI interpretation errors may guide a direction of improving object recognition performance and even enable enhancements such as replacing or modifying AI algorithms related to object recognition.

The above description is merely illustrative of the technical idea of the present disclosure, and those skilled in the art to which the present disclosure pertains may make various modifications and variations without departing from the essential characteristics of the present disclosure.

Therefore, the examples disclosed in the present disclosure are not intended to limit the technical ideas of the present disclosure, but to explain them, and the scope of the technical ideas of the present disclosure is not limited by these examples. The protection range of the present disclosure should be interpreted by the claims below, and all technical ideas within the equivalent range should be interpreted as being included in the scope of the present disclosure.

What is claimed:

1. A method performed by an apparatus of a vehicle, the method comprising:
inputting, based on at least one ground truth (GT) bounding box being set for an object, a three-dimensional (3D) image obtained from a sensor into a first evaluation circuit of the apparatus, wherein the first evaluation circuit is coupled to the sensor and a learning model, and wherein the 3D image comprises a plurality of objects including the object;
obtaining, based on the learning model and multiple predictions, a plurality of predicted bounding boxes, wherein the plurality of predicted bounding boxes recognize the object from the 3D image;
determining, by the first evaluation circuit, an intersection over union (IoU) value by respectively comparing each of the plurality of predicted bounding boxes with the at least one GT bounding box;
identifying a count of false negatives (FNs), a count of true positives (TPs), and a GT matching predicted bounding box, based on whether the IoU value is 0 and which predicted bounding box has a maximum IoU value relative to the at least one GT bounding box;
measuring, by the first evaluation circuit, object recognition accuracy of the learning model by determining, based on the count of FNs, the count of TPs, and the GT matching predicted bounding box, at least one error of:
an object position error for each of the plurality of objects,
an object size error for each of the plurality of objects, or
an object heading error for each of the plurality of objects; and
outputting a signal indicating the measured object recognition accuracy of the learning model and the determined at least one error; and
controlling, based on the signal, autonomous driving of the vehicle.

2. The method of claim 1, wherein the measuring of the object recognition accuracy comprises:
determining whether object recognition results remain the same in a case where a front orientation and a back orientation of the GT matching predicted bounding box are reversed; and
based on determining that the object recognition results differ, determining the object heading error by dividing the object heading error into an average heading error (AHE) and an average direction error (ADE), wherein the AHE and ADE are mutually independent metrics.

3. The method of claim 2, further comprising:
determining a value of a recognition error of the object within a range of 0 to 1 by assigning a maximum error value of 1 to prediction results corresponding to false negatives (FNs) among the plurality of predicted bounding boxes.

4. The method of claim 3, wherein the determining of the value of the recognition error of the object comprises:
determining an average error of the plurality of predicted bounding boxes based on the object position error, the object size error, and the object heading error, and
determining, based on the determined average error, a recognition error of the object from the 3D image obtained from the sensor.

5. The method of claim 1, further comprising:
selecting, based on two or more predicted bounding boxes having non-zero IoU values, a predicted bounding box having a highest IoU value as the GT matching predicted bounding box.

6. The method of claim 1, further comprising:
determining an average location error (ALE) as the object position error, wherein the ALE is determined as a function of:
a number of predicted bounding boxes that have received the TP identification,
a number of predicted bounding boxes that have received the FN identification,
a plurality of correction variables associated with a central coordinate of the predicted bounding box and a central coordinate of the GT bounding box, and
a Euclidean distance between the central coordinate of the predicted bounding box and the central coordinate of the GT bounding box.

7. The method of claim 6, wherein the plurality of correction variables comprises a first correction variable and a second correction variable that are natural numbers, and
wherein the method further comprises:
determining a mode value from a plurality of Euclidean distances between central coordinates of predicted bounding boxes and central coordinates of GT bounding boxes;
identifying, through a search process, a natural number that most closely approximates the mode value by incrementing the first correction variable from 1 in units of 1; and
setting the identified natural number as the second correction variable.

8. The method of claim 7, wherein the Euclidean distance, the first correction variable, and the second correction variable are related such that:
a second derivative of a hyperbolic tangent function, applied to a product of the second correction variable and the Euclidean distance, equals zero at an inflection point, and
the Euclidean distance is inversely proportional to the second correction variable and varies based on a ratio involving a square root term derived from the first correction variable.

9. The method of claim 1, further comprising:
determining an average dimension error (ADME) as the object size error, wherein the ADME is determined as a function of:
a number of predicted bounding boxes that have received the TP identification,
a number of predicted bounding boxes that have received the FN identification, and
an IoU value.

10. The method of claim 2, further comprising:
determining the AHE as a function of:
a number of predicted bounding boxes that have received the TP identification,
a number of predicted bounding boxes that have received the FN identification,
a direction angle of the predicted bounding box,
a direction angle of the GT bounding box, and
a cosine-based expression representing a difference between the direction angle of the predicted bounding box and the direction angle of the GT bounding box.

11. The method of claim 2, further comprising:
determining the ADE as a function of:
a number of predicted bounding boxes that have received the TP identification,
a number of predicted bounding boxes that have received the FN identification,
a direction angle of the predicted bounding box,
a direction angle of the GT bounding box, and
a comparison operation based on a difference between the direction angle of the predicted bounding box and the direction angle of the GT bounding box equaling or exceeding a threshold angle.

12. An apparatus of a vehicle, the apparatus comprising:
a processor; and
a memory storing at least one instruction that, when executed by the processor communicating with the memory, is configured to cause the apparatus to:
obtain, via a sensor of the vehicle, sensor data and a ground truth (GT) bounding box, wherein the sensor data comprises a two-dimensional or three-dimensional image sensor data;
recognize, based on a learning model, an object from the sensor data; and
measure recognition accuracy of the learning model by determining an error between the recognized object and objects in an environment represented by the sensor data, even when a GT bounding box corresponding to a recognized object is absent.

13. The apparatus of claim 12, wherein the at least one instruction, when executed by the processor communicating with the memory, is configured to cause the apparatus to:
recognize sensor data containing one or more objects belonging to at least one of a plurality of classes, while receiving at least one GT bounding box, repeatedly determine a predicted bounding box by recognizing the object based on the learning model from the sensor data,
for each GT bounding box of the at least one GT bounding box, respectively compare the predicted bounding boxes obtained by the repeated determination with the at least one GT bounding box to determine an intersection over union (IoU) value,
identify a count of false negatives (FNs), a count of true positives (TPs), and GT matching predicted bounding boxes that are determined to match the at least one GT bounding box based on whether the IoU value is 0 and which predicted bounding box has a maximum IoU value, and
measure the recognition accuracy of the learning model by determining, based on the count of FNs, the count of TPs, and the GT matching predicted bounding boxes, at least one error of:
an object position error for each of a plurality of objects,
an object size error for each of the plurality of objects, or
an object heading error for each of the plurality of objects.

14. The apparatus of claim 13, wherein the at least one instruction, when executed by the processor communicating with the memory, is configured to cause the apparatus to:
determine whether object recognition results remain the same in a case where a front orientation and a back orientation of the GT matching predicted bounding boxes are reversed, and
based on a determination that the object recognition results differ, determine the object heading error by dividing the object heading error into an average heading error (AHE) and an average direction error (ADE), wherein the AHE and ADE are mutually independent metrics.

15. The apparatus of claim 14, wherein the at least one instruction, when executed by the processor communicating with the memory, is configured to cause the apparatus to:
determine a value of a recognition error of the object within a range of 0 to 1 by assigning a maximum error value of 1 to prediction results corresponding to false negatives (FNs) among the predicted bounding boxes.

16. The apparatus of claim 14, wherein the at least one instruction, when executed by the processor communicating with the memory, is configured to cause the apparatus to:
determine an average error of the plurality of predicted bounding boxes based on the object position error, the object size error, and the object heading error, and
determine, based on the determined average error, a recognition error of the object from a 3D image obtained from the sensor.

17. The apparatus of claim 13, wherein the at least one instruction, when executed by the processor communicating with the memory, is configured to cause the apparatus to determine an average location error (ALE) as the object position error, wherein the ALE is determined as a function of:
a number of predicted bounding boxes that have received the TP identification,
a number of predicted bounding boxes that have received the FN identification,
a plurality of correction variables associated with a central coordinate of the predicted bounding box and a central coordinate of the GT bounding box, and
a Euclidean distance between the central coordinate of the predicted bounding box and the central coordinate of the GT bounding box.

18. The apparatus of claim 13, wherein the at least one instruction, when executed by the processor communicating with the memory, is configured to cause the apparatus to determine an average dimension error (ADME) as the object size error, wherein the ADME is determined as a function of:
a number of predicted bounding boxes that have received the TP identification,
a number of predicted bounding boxes that have received the FN identification, and
an IoU value.

19. A method performed by an apparatus of a vehicle, the method comprising:
obtaining sensor data and reference data, wherein the sensor data represents a surrounding environment of the vehicle, and wherein the reference data comprises ground truth data including an annotation representing an object in the surrounding environment;
identifying, using a learning model, at least one predicted object region from the sensor data;
determining, based on a similarity measure between the at least one predicted object region and the reference data, a predicted object region, wherein the predicted object region corresponds to the object;
outputting a signal indicating at least one error value associated with the predicted object region, wherein the at least one error value comprises at least one of a position error, a size error, a heading error, or a directionality error; and
controlling, based on the signal, autonomous driving of the vehicle.

20. The method of claim 19, wherein the position error is determined by applying a hyperbolic tangent function to a distance between a center of the predicted object region and a center of the object associated with the reference data, such that effects of distance values larger than a threshold value are reduced.
